(19) United States
(12) Patent Application Publication
(10) Pub. No.: US 2015/0358274 A1
(43) Pub. Date: Dec. 10, 2015

(54) INFORMATION PROVIDING DEVICE

(71) Applicant: DENSO CORPORATION, Kariya-city (JP)

(72) Inventors: YUUYA HATTORI, Iwakura-city (JP); KATSUSHI ASAMI, Nukata-gun (JP)

(21) Appl. No.: 14/727,925

(22) Filed: Jun. 2, 2015

(30) Foreign Application Priority Data
Jun. 6, 2014 (JP) 2014-117866

(51) Int. Cl. H04L 12/58; G06F 17/30

(52) U.S. Cl. CPC H04L 51/32; G06F 17/30876

(57) ABSTRACT

An information providing device includes a post information acquiring section acquiring one or more information elements posted by one or more posters, a post situation estimation section estimating a post situation of each of the one or more information elements, the post situation being a situation under which the corresponding information element is posted by the poster, a device situation acquiring section acquiring a device situation under which the information providing device is placed, a determination selection section determining a suitability of the device situation with a general situation of the one or more information elements posted by the posters and selecting one or more target information elements from the one or more information elements based on the suitability, and a providing section providing an information to the user based on the one or more target information elements selected based on the suitability.

### CROSS REFERENCE TO RELATED APPLICATION

This application is based on Japanese Patent Application No. 2014-117866 filed on Jun. 6, 2014, the disclosures of which is incorporated herein by reference.

### TECHNICAL FIELD

The present disclosure relates to an information providing device that provides information to a user.

### BACKGROUND

As disclosed in JP 2013-127399 A, an information providing device guides a user to a facility that is highly evaluated by online messages posted on an online message board, such as a social network service (SNS).

The above-described information providing device provides information only based on the feedback messages that give high evaluation to the facility. With this configuration, in some cases, information that is out of season or information that does not meet with a current situation of the user may be provided to the user.

### SUMMARY

In view of the foregoing difficulties, it is an object of the present disclosure to provide an information providing device which properly provides, to a user, information that is valuable and suitable to the user.

According to an aspect of the present disclosure, an information providing device includes a post information acquiring section acquiring one or more information elements posted by one or more posters, a post situation estimation section estimating a post situation of each of the one or more information elements, the post situation being a situation under which the corresponding information element is posted by the poster, a device situation acquiring section acquiring a device situation under which the information providing device is placed, a determination selection section determining a suitability of the device situation with a general situation of the one or more information elements posted by the posters and selecting one or more target information elements from the one or more information elements based on the suitability, and a providing section providing an information to the user based on the one or more target information elements selected based on the suitability.

With the above device, the user can be properly provided with more valuable and suitable information.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of an information providing device according to an embodiment of the present disclosure;

FIG. 2 is a flowchart showing an information providing process executed by a CPU of a controller;

FIG. 3 is a flowchart showing an output candidate extraction sub process executed by the controller according to a first embodiment of the present disclosure;

FIG. 4 is a flowchart showing a post situation estimation sub process executed by the controller;

FIG. 5 is a flowchart showing an estimation sub process executed by the controller;

FIG. 6 is a diagram showing an exemplary display window that is displayed to the user for providing multiple kinds of information;

FIG. 7 is a diagram showing another exemplary display window that is displayed to the user for providing multiple kinds of information;

FIG. 8 is a diagram showing another exemplary display window that is displayed to the user for providing multiple kinds of information;

FIG. 9 is a flowchart showing a statistical information preparation process executed by a CPU of a controller;

FIG. 10A to FIG. 10C are diagrams showing exemplary histograms of facilities;

FIG. 11A to FIG. 11C are diagrams showing exemplary average histograms of facilities; and

FIG. 12 is a flowchart showing an output candidate extraction process according to a second embodiment of the present disclosure.

### DETAILED DESCRIPTION

The following will describe embodiments of the present disclosure with reference to the accompanying drawings.

### First Embodiment

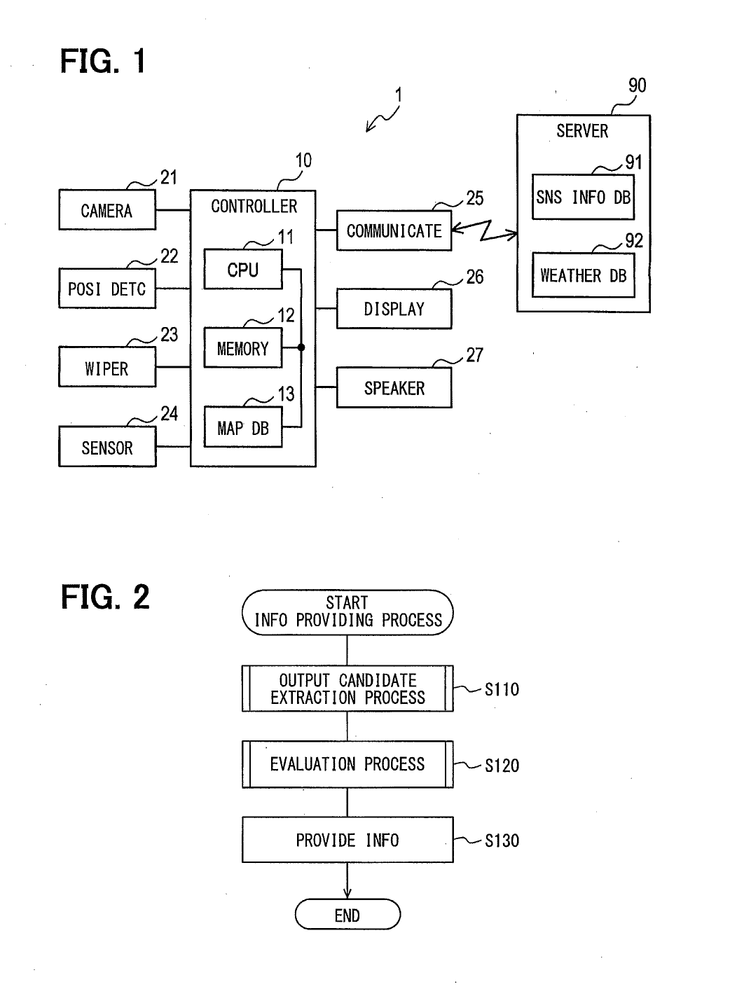

As shown in FIG. 1, an information providing device 1 according to the present disclosure is equipped to a vehicle. For example, the information providing device 1 may be equipped to a passenger vehicle. The information providing device 1 generates information that is valuable and suitable to a user based on online messages posted on an online message board, such as SNS. Then, the information providing device 1 provides the generated information to the user.

As shown in FIG. 1, the information providing device 1 includes a controller 10, a camera 21, a position detector (POSI DETC) 22, a wiper 23, various kinds of sensors 24, a communication unit (COMMUNICATE) 25, a display unit (DISPLAY) 26, and a speaker 27. The camera 21 takes images of an inside of the vehicle and transmits the taken images to the controller 10. More specifically, the camera 21 takes images of an inside of a compartment of the vehicle. The image taken by the camera 21 may indicate the number of on-board passengers and may also indicate whether the on-board passengers include a child or not. A confirmation of the number of the passengers and a confirmation of the presence of the child may be carried out based on a publicly known face recognition technology and age estimation technology disclosed in JP 2005-148880 A.

The position detector 22 may be provided by a global positioning system (GPS) receiver, and transmits position information of the vehicle to the controller 10. The wiper 23 wipes off water drops from a windshield or a rear window of the vehicle. The controller 10 is able to identify an operation state of the wiper 23.

The sensors 24 may include a vehicle speed sensor that detects a travelling speed of the vehicle, a thermometer that detects an external temperature outside of the vehicle, an occupant detection sensor that detects whether an occupant is seated on a seat of the vehicle. Each sensor 24 transmits a detection result to the controller 10.

The communication unit 25 is provided by a well-known communication module that performs a wireless communication with a server 90. The server 90 is positioned outside of the vehicle. The communication unit 25 transmits, to the server 90, data under a transmitting command from the controller 10. The communication unit 25 also receives data, which is transmitted from the server 90, and transmits the received data to the controller 10.

The display unit 26 is provided by a well-known display device, such as a liquid crystal display device or a head-up display device. The display unit 26 displays an image on a screen based on an image signal transmitted from the controller 10. The speaker 27 outputs sound waves based on an audio signal transmitted from the controller 10.

The controller 10 is provided by a general purpose computer which includes a central processing unit (CPU) 11, a memory unit 12 including a read-only memory (ROM) and a random access memory (RAM). The CPU 11 executes various kinds of processes based on programs stored in the memory unit 12.

The controller 10 includes a map database (MAP DB) 13. The map database 13 is a well-known database for storing map information, and is widely used in a navigation technology field. The map database 13 stores road information and facility information as the map information. Each of the road information and facility information is correlated to latitude and longitude position information. The roads and the facilities indicated by the road information and the facility information are used when guiding, to a user, a route to a destination.

The server includes a SNS information database (SNS INFO DB) 91 and a weather data database (WEATHER DB) 92. The SNS information database 91 stores multiple pieces of messages that are posted on a SNS message board by network users.

The weather data database 92 stores weather information and temperature information at respective positions that are preliminarily registered. When the server 90 receives a request from the vehicle, the server 90 reads out necessary information from each database 91, 92, and transmits the readout information to the vehicle.

The following will describe an information providing process executed by the controller 10 of the information providing device 1 with reference to FIG. 2. The controller 10 starts the information providing process when the information providing device 1 is supplied with power and is turned on. The controller 10 executes the information providing process at predetermined time intervals.

As shown in FIG. 2, when the information providing process starts, the controller 10 executes an output candidate extraction process at S110. In the output candidate extraction process, the controller 10 extracts multiple pieces of SNS information elements that are posted under situations similar to the user's situation as the output candidates. A target information element to be provided to the user is generated based on the output candidates.

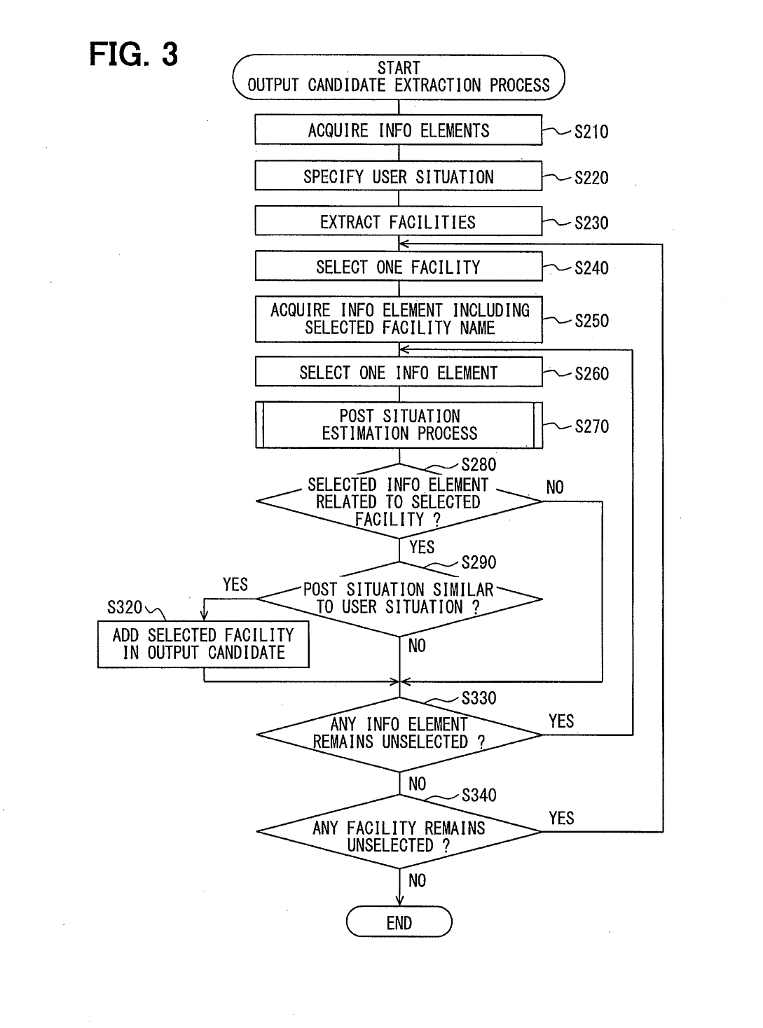

As shown in FIG. 3, in the output candidate extraction process, the controller 10 acquires various kinds of information elements related to the user at S210. Herein, various kinds of information elements include detection results output from the camera 21, the position detector 22, or the multiple sensors 24. The various kinds of information also include operation state of the wiper 23 and the weather information acquired from the server 90.

Excepting acquiring the weather information from the server 90, the controller 10 may also determine the weather condition, such as raining, based on the operation state of the wiper 23. As described above, the camera 21 acquires the number of on-board passengers. As another example, the occupant detection sensor may detect the number of on-board passenger by detecting whether an occupant is seated on a seat of the vehicle.

At S220, the controller 10 specifies a user situation. Specifically, the controller 10 estimates time, season, weather, temperature, the number of passengers, presence of a child, or an empty stomach of the user as the user situation based on the various kinds of information acquired at S210. The user situation also indicates a device situation under which the information providing device 1 is placed. The controller 10 may determine the empty stomach of the user based on the travel history of the vehicle, for example, by determining how long before the user has parked the vehicle near a restaurant. As another example, the controller 10 may determine the empty stomach of the user by determining whether the current time is around a mealtime.

At S230, the controller 10 extracts facilities positioned around the vehicle. Specifically, the controller 10 may extract facilities positioned within a predetermined distance from the present position of the vehicle, or may extract facilities positioned within a predetermined distance from a destination of the vehicle. For example, the predetermined distance from the present position of the vehicle may be set as 10 kilometers, and the predetermined distance from the destination of the vehicle may be set as 20 kilometers.

At S240, the controller 10 selects a new facility from the facilities extracted at S230. Herein, the new facility is a facility that has not been selected by the controller 10. At S250, the controller 10 requests the server 90 to provide one or more posted information elements each including the name of the selected facility, and receives one or more posted information elements each including the name of the selected facility from the server. The specific distance may be configured to be settable by the user.

At S260, the controller 10 selects a new information element from the acquired information elements. Herein, the new information element is an information element that has not been selected by the controller 10 during the output candidate extraction process. At S270, the controller 10 performs a post situation estimation process. In the post situation estimation process, the controller 10 estimates a post situation under which the information element, for example, the online message is posted by a poster.

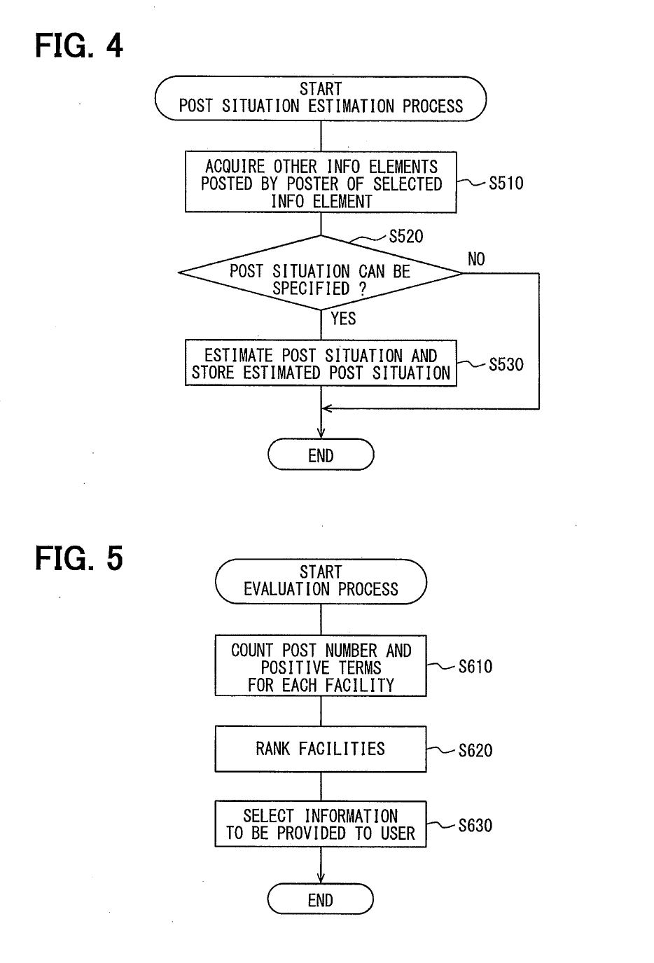

As shown in FIG. 4, in the post situation estimation process, the controller 10 requests the server 90 to provide other information elements, that is, additional information elements posted by the same poster of the information element selected at S260. Herein, the poster is an internet user who posts the information element, such as an online message, to an online message board. The controller 10 requests the server 90 to provide other information elements posted before or after the selected information element by a predetermined period. For example, the controller 10 may request the server 90 to provide other information elements posted by the same poster on the same day with the selected information element.

At S520, the controller 10 determines whether the post situation of the poster of the selected information element is able to be identified based on the information elements acquired at S510.

For example, the controller 10 may determine that the situation of the poster of the selected information can be identified in the following cases. Herein, the selected information element is the information element selected at S260.

(I) When information indicating a position of the poster, such as GPS information is attached to or included in the selected information, the controller 10 determines that the situation of the poster of the selected information is able to be identified.

(II) When the controller 10 is able to acquire and specify weather information of the facility at the post time of the selected information element, the controller 10 determines that the situation of the poster of the selected information is able to be identified.

(III) When the posted information element includes or is attached with an image and the number of the persons included in the image or the presence of the child is able to be determined by performing an image processing, the controller 10 determines that the situation of the poster of the selected information is able to be identified.

(IV) When an information element related to meal is posted immediately before the selected information element and non-empty stomach of the poster is confirmed, the controller 10 determines that the situation of the poster of the selected information is able to be identified.

(V) When an information element related to meal is posted immediately before the selected information element and empty stomach of the poster is confirmed, the controller 10 determines that the situation of the poster of the selected information is able to be identified.

As described above, when the information indicating the post situation of the poster is included in any one of the information elements posted by the same poster, the controller 10 determines that the post situation of the poster of the selected information is able to be identified.

When determining a posted information element is related to a meal or not, the controller 10 may determine whether the posted information element includes a keyword, such as “lunch”, “meal”, or “delicious”. As another example, as disclosed in JP 2012-14678 A (corresponding to US 2013/0170714 A1), the controller 10 may determine whether a posted information element is related to a meal or not by recognizing whether an image included in or attached to the posted information includes food or drink.

At S520, when the controller 10 fails to estimate the situation of the poster (S520: NO), the controller 10 ends the post situation estimation process. When the controller 10 is able to determine the post situation of the poster (S520: YES), the controller 10 estimates the post situation of the poster and stores the post situation of the poster correlated to the selected information element at S530. Then, the controller 10 ends the post situation estimation process, and returns to S280 in FIG. 3.

At S280, the controller 10 determines whether the selected information element is related to the selected facility. Herein, the selected facility is the facility selected at S240. For example, when the position where the selected information element is posted is far from the position of the selected facility, the controller 10 may determine that the selected information element is not related to the selected facility.

When the controller 10 determines that the selected information element is not related to the selected facility (S280: NO), the controller proceeds to S330. When the controller 10 determines that the selected information is related to the selected facility (S280: YES), the controller 10 proceeds to S290.

When determining whether the selected information element is related to the selected facility, the controller compares the user situation specified at S220 with the post situation of the poster estimated in the post situation estimation process. For example, the controller 10 may compare multiple items included in the user situation with corresponding items included in the post situation of the poster of the selected information element. When more than half of the situation items of the user situation are similar to the post situation, the controller 10 may determine that the user situation is similar to the post situation of the poster of the selected information element. Herein, the situation items may include time, season, weather, temperature, the number of persons, presence of child, and empty state of the stomach or the like.

When the post situation of the poster of the selected information element is not similar to the user situation (S290: NO), the controller 10 proceeds to S330. When the post situation of the poster of the selected information element is similar to the user situation (S290: YES), the controller 10 outputs the selected facility as an output candidate, and registers the selected facility in the memory unit 12 at S320. The information element corresponding to the selected facility is stored in the memory unit 12 together with the selected facility.

At S330, the controller 10 determines whether an information element acquired at S250 remains unselected. When the controller 10 determines that an information element acquired at S250 remains unselected (S330: YES), the controller 10 returns to S260. When the controller 10 determines that there is no information element remains unselected (S330: NO), the controller 10 further determines whether a facility extracted at S230 remains unselected at S340. When the controller 10 determines that a facility extracted at S230 remains unselected (S340: YES), the controller 10 returns to S240. When the controller 10 determines that there is no facility remains unselected (S340: NO), the controller 10 ends the output candidate extraction process.

After ending the output candidate extraction process, the controller 10 returns to S120 shown in FIG. 2 and performs an evaluation process. In the evaluation process, the controller 10 selects a target facility to be provided to the user as the target information element from the facilities, which are extracted as output candidates in the output candidate extraction process.

As shown in FIG. 5, in the evaluation process, with respect to each facility extracted as the output candidate in the output candidate extraction process, the controller 10 determines the number of the posted information elements and counts positive terms included in the posted information elements at S610. Herein, the positive terms are terms that give the positive evaluation to the facility, such as “delicious”, “beautiful”, “nice”, or “good”.

At S620, the controller 10 ranks the facilities according to the count number of the positive terms. Specifically, the controller 10 gives a higher rank to the facility that has greater number of the positive terms.

At S630, the controller 10 selects a target facility to be provided to the user according to the ranking of the facilities. Specifically, the controller 10 may select a facility that has a maximum count number of the positive terms as the target facility. As another example, the controller 10 may rank the facilities in a decreasing order of the count number of the positive terms, and selects predetermined number of facilities from the most highly ranked facility. Then, the controller 10 ends the evaluation process.

After ending the evaluation process, the controller 10 returns to S130 of FIG. 2. At S130, the controller 10 generates, based on the selected one or more facilities, information to be provided to the user, and provides the generated information to the user. Specifically, among the facilities corresponding to the candidate outputs, a facility that has a higher rank is estimated to meet needs of the user, and is highlighted when the facility is displayed to the user on a display screen of the display unit 26.

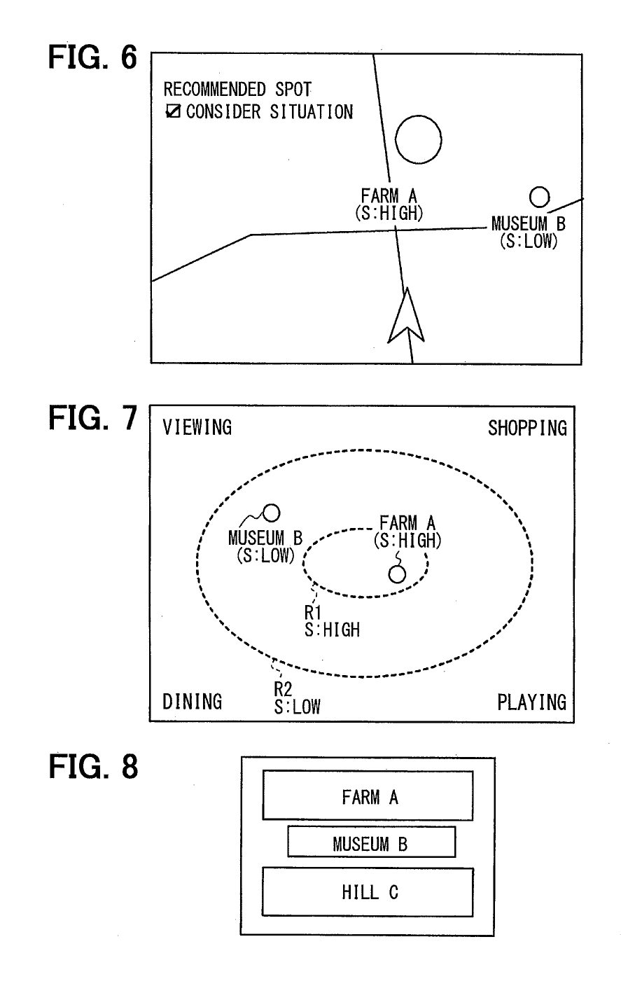

As shown in FIG. 6, when the information to be provided to the user includes farm A and museum B and the farm A has a higher suitability (S) than the museum B, an image signal is generated so that a display size of the farm A is enlarged than a display size of the museum B when displayed on the screen. The facility having a higher suitability corresponds to a facility having a higher rank.

In the example shown in FIG. 6, the display size of the facility on the map is changed according to the facility suitability to the user. As another example, as shown in FIG. 7, among multiple facilities, a facility that has a higher suitability may be positioned within a higher suitability area R1, and a facility that has a lower suitability may be positioned with in a lower suitability area R2. For example, each facility may be classified into one or more categories, such as, viewing, shopping, playing, dining arranged at four corners of the display window. A rank of the facility in each category may be preliminarily determined. A facility that has a high rank may be displayed at a central portion, which is the higher suitability area R1, and the display position of a facility may be moved closer to a periphery of the display window with a decrease of the rank in a direction from the center to the corresponding category on each corner of the display window. As another example, as shown in FIG. 8, a facility list may be generated and displayed to the user. In the facility list shown in FIG. 8, a facility that has a higher suitability may be displayed in a greater display size compared with a facility that has a lower suitability. In the example shown in FIG. 8, farm A and hill C having the higher suitability are displayed in the greater display size, and the museum B having the lower suitability is displayed in the smaller display size.

With above-described display mode shown in FIG. 7, the facilities that have higher ranks in all of the categories are displayed at the central portion of the display window, and the user is easy to confirm and select the facility that has higher ranks in all of the categories. When the user fails to select a facility, the user may narrow down the category of his or her interest, and may confirm and select one facility of the narrowed down category by moving his or her eye in the direction toward the target category.

With above-described display mode shown in FIG. 8, multiple facilities are displayed in a list. In this case, the facility having a higher suitability may be displayed in an enlarged size or different color in order to highlight the facility having higher suitability. In the present embodiment, the display mode of the display window may settable by the user in advance so that the facilities having higher ranks are displayed in highlighted manner. Alternatively, after a predetermined display window is generated, the user may switch a default display mode to a different display mode according to his or her own like.

The following will describe advantages provided by the information providing device 1 according to the present embodiment.

In the information providing device 1 according to the present embodiment, the controller 10 acquires one or more information elements posted by one or more posters, and estimates a post situation for each of the information elements. Herein, the post situation is a situation under which the information element is posted by the poster, and may include a position, time, or the number of persons moving in company with the poster. The information providing device 1 also acquires a device situation under which the information providing device 1 is placed, and determines a suitability of the device situation with a general situation of the poster. Herein, the device situation may be provided by the user situation determined at S220 of FIG. 3, and the general situation of the poster is determined based on the one or more information elements posted by the poster. Then, the information providing device 1 selects one or more target information elements based on the suitability. Then, the information providing device 1 provides the target information element to the user.

In the above-described information providing device 1, the target information element is selected based on the suitability of the device situation with the general situation. Herein, the general situation is comprehensively defined based on the post situations of the information elements. Thus, information that is more valuable and suitable to the user can be provided to the user.

In the information providing device 1 according to the present embodiment, the post situation includes post position information that indicates a post position where the corresponding information element is posted by the poster. The device situation includes device position information that indicates a device position where the information providing device 1 is currently positioned. Then, the controller 10 determines, for each of the one or more information elements, a matching degree of the device situation with the post situation of the corresponding information element by comparing the device position with the post position of the corresponding information element, and determines the suitability of the device situation with the general situation of the one or more information elements based on the matching degrees of the device situation with the respective position situations of the one or more information elements. Then, the controller 10 selects the one or more target information elements based on the suitability.

With the above-described information providing device 1, the post position at which the information element is posted by the poster and the device position of the information providing device 1 are considered when determining the suitability. Thus, information that is more suitable to the user can be provided to the user.

In the information providing device 1 according to the present embodiment, the controller 10 determines the post situation based on a specific content included in the corresponding information element by confirming the keywords as described above.

With above-described information providing device 1, since the post situation can be easily estimated based on the specific content of the posted information element, there is no necessity to additionally acquiring a post situation.

In the information providing device 1 according to the present embodiment, for each of the one or more information elements, the controller 10 acquires other information elements posted by the same poster of the corresponding information element, and estimates the post situation of the corresponding information element with consideration of the other information elements posted by the same poster.

With above-described information providing device 1, the post situation can be estimated based on one or more information elements posted by the same poster. Thus, even when the selected information element has small number of words, such as a message posted on SNS, the post situation can be estimated at a higher accuracy and a higher suitability by considering greater number of information elements posted by the same poster.

In the information providing device 1 according to the present embodiment, the controller 10 determines a total number of one or more persons moving in company with the poster by recognizing an image included in the corresponding information element as at least a part of the post situation. Specifically, the number of the passengers may be determined by recognizing the image included in the posted information element.

With above-described configuration, a facility that is usually visited by multiple persons, such as an amusement park, may be avoided to be provided to the user who travels by himself or herself only. Thus, a providing of the information that does not meet with the situation of the user can be avoided.

In the information providing device 1 according to the present embodiment, the controller 10 changes a notification mode corresponding to a suitability level of each of the one or more target information elements. Specifically, the controller 10 changes a notification mode of the information corresponding to a rank of the target facility to be provided to the user as shown in FIG. 7 to FIG. 9. For example, as the notification mode, the controller 10 changes display color, display size, or audio type.

With above-described configuration, the user is easily notified of the information element having a higher suitability compared with the information element having a lower suitability.

### Second Embodiment

The following will describe an information providing device 2 according to a second embodiment of the present disclosure. The following will describe only the different parts of the device 2 from the device 1 according to the first embodiment. Description of the same part of the device 2 with the device 1 according to the first embodiment will be omitted.

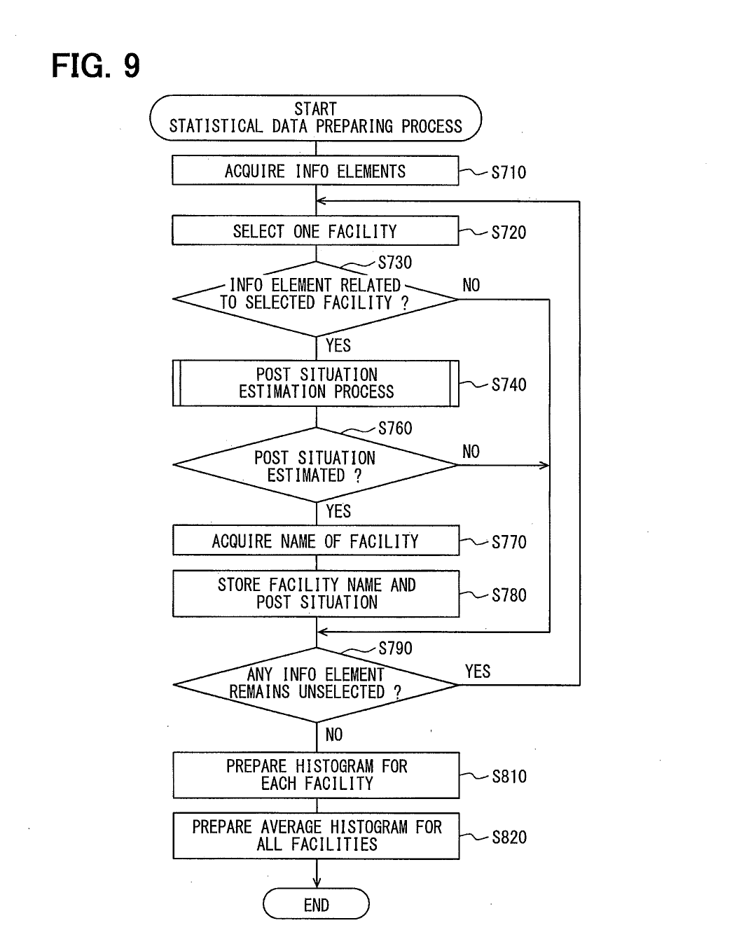

The information providing device 2 according to the present embodiment processes multiple posted information elements to generate a statistical data, and generates the information to be provided to the user based on the statistical data. In the present embodiment, the controller 10 executes the statistical data preparing process before the information providing process. The following will describe the statistical data preparing process with reference to FIG. 9.

The controller 10 may start the statistical data preparing process in response to the power supply and turning on of the information providing device 2. The controller 10 may start the statistical data preparing process at any time after the information providing device 2 is turned on. As shown in FIG. 9, the controller 10 acquires, from the SNS database 91 of the server 90, multiple information elements posted by multiple posters at S710.

At 720, the controller 10 selects a new information element from the acquired information elements. Herein, the new information element is an information element that has not been selected by the controller 10 in the statistical data preparing process. At S730, the controller 10 determines whether the selected information element is related to a facility. Specifically, when determining whether the selected information element is related to a facility, the controller 10 may determine whether the selected information element includes text information related to a name of a predetermined facility.

When the controller 10 determines that the selected information element is not related to a facility (S730: NO), the controller 10 proceeds to S790. When the controller 10 determines that the selected information element is related to a facility (S730: YES), the controller 10 proceeds to S740 and performs the post situation estimation process. The post situation estimation process is similar to the post situation estimation process according to the first embodiment.

At S760, the controller 10 determines whether the post situation of the selected information element can be estimated or not. When the controller 10 determines that the post situation of the selected information element cannot be estimated (S760: NO), the controller 10 proceeds to S790.

When the controller 10 determines that the post situation of the selected information element can be estimated (S760: YES), the controller acquires the name of the facility from the post situation at S770. Then, the controller 10 registers the name of the facility correlated to the post situation in the memory unit 12.

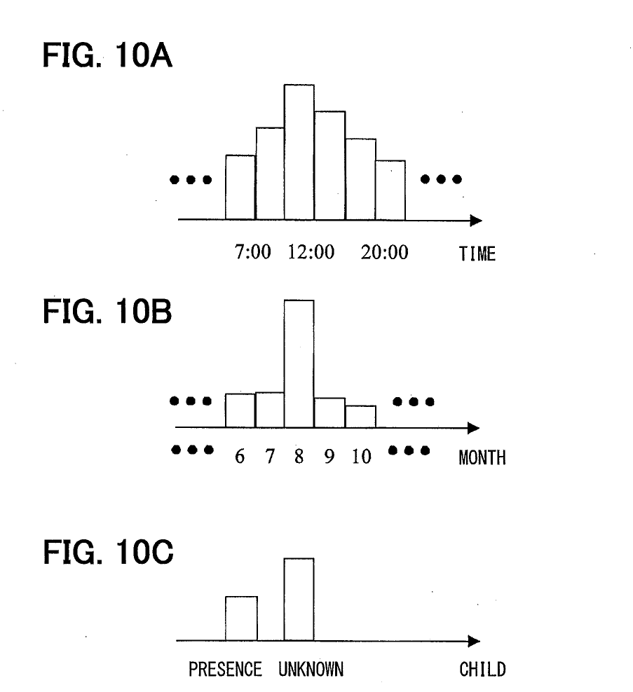

At S790, the controller 10 determines whether an information element acquired at S710 remains unselected. When the controller 10 determines that an information item acquired at S710 remains unselected (S790: YES), the controller 10 returns to S720. When the controller 10 determines that there is no information item remains unselected (S790: NO), the controller 10 generates, for each facility, a histogram at S810. The histogram is also referred to as a distribution graph. Specifically, the controller 10 generates a histogram showing the time when the information elements are posted for the corresponding facility as shown in FIG. 10A. The controller 10 also generates a histogram showing the month when the information elements are posted for the corresponding facility as shown in FIG. 10B. The controller 10 also generates a histogram showing the presence of the child for the corresponding facility as shown in FIG. 10C.

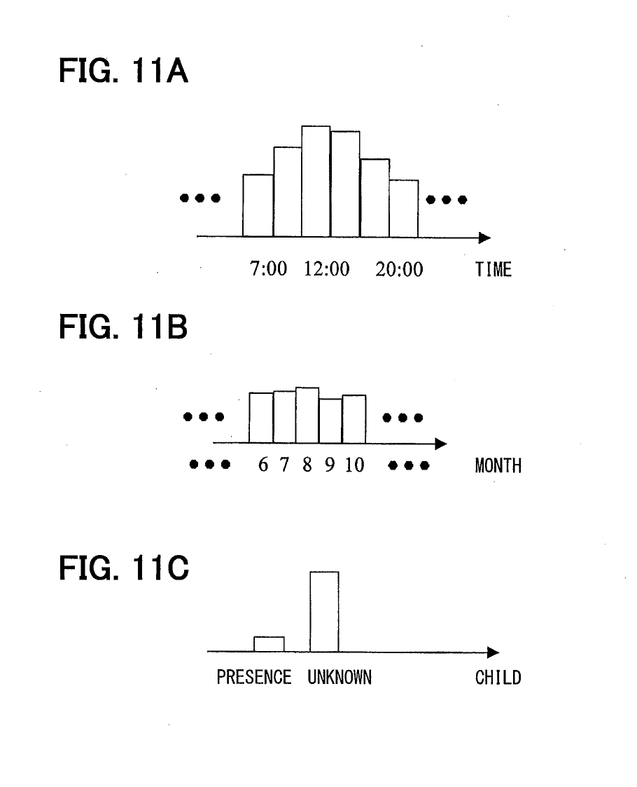

At S820, the controller generates an average histogram for all of the facilities. As shown in FIG. 11A to FIG. 11C, with respect to all of the posted information elements from which facility names can be specified, the controller 10 generates the average histogram showing the time when the information elements are posted as shown in FIG. 11A, the average histogram showing the month when the information elements are posted as shown in FIG. 11B, and the average histogram showing the presence of the child as shown in FIG. 11C. Then, the controller 10 ends the statistical data preparing process.

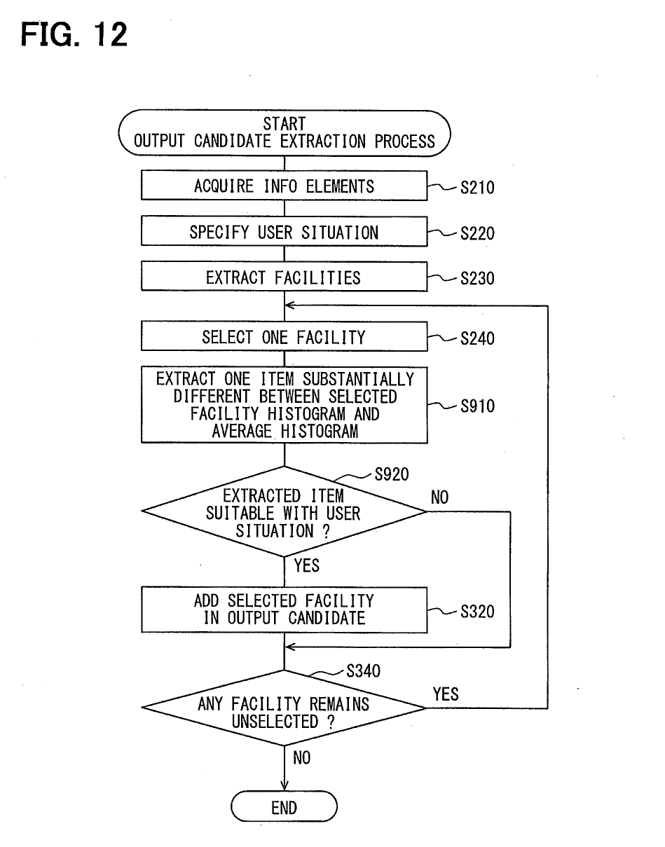

The controller 10 according to the present embodiment performs the output candidate extraction process shown in FIG. 12. The following will describe different part of the process from the output candidate extraction process according to the first embodiment. After S240, the controller 10 compares the histogram of the selected facility with the average histogram, and extracts an item that is substantially different between the histogram of the selected facility and the average histogram at S910. The item is a part of the distribution graph of the selected facility, which is substantially have different level from the average distribution graph.

For example, suppose that the controller 10 compares the histograms shown in FIG. 10A to FIG. 10C with the respective histograms shown in FIG. 11A to FIG. 11C. In this case, the average number of the posted information elements are relatively small in each month as shown in FIG. 11B, while the number of the posted information elements for the selected facility is substantially great in August as shown in FIG. 10B. Thus, the controller 10 extracts August as the item.

At S920, the controller 10 determines whether the extracted item that has a substantially great difference from the average level matches with the user situation. For example, when the information post month of August is extracted, the controller 10 determines whether the current time for providing information is equal to August or not.

For example, when the number of the posted information elements for the selected facility is substantially small in August and the current time for providing information is not equal to August, the controller 10 may determine the user situation matches with the average histogram.

When the controller 10 determines that the extracted item that has a substantially great difference from the average level does not match with the user situation (S920: NO), the controller proceeds to S340. When the controller 10 determines that the extracted item that has a substantially great difference from the average level matches with the user situation (S920: YES), the controller 10 proceeds to S320. Both at S320 and S340, the controller 10 perform respective executions similar to the executions described in the first embodiment. After executing the process at S320, the controller 10 proceeds to S340.

With above-described information providing device 2, the suitability can be determined based on the statistical data generated based multiple posted information elements. In the present embodiment, the statistical data functions as the general situation. Thus, the information providing device 2 according to the present embodiment is able to select and provide more valuable and suitable information to the user.

When a situation is difficult to be estimated even based on all of the information elements posted by the same poster, the suitability of the user situation (device situation) with the general situation can be properly determined using the statistical data as the general situation. For example, determining the presence of the child is difficult when the all of the information elements posted by a poster do not include an image. In this case, since it is hard to say that the poster who posted the information elements have not bring a child with him or her, the suitability is hard to be determined based on a single information element.

In the present embodiment, the controller 10 provides the average histogram of each facility. When the level indicating the presence of the child in the selected facility is higher than the corresponding level in the average histogram, the controller 10 can determine it is better to provide the information of the facility to the user who brings a child with him or her. When the level indicating the presence of the child in the selected facility is lower than the level in the average histogram, the controller 10 can determine it is better to provide the information of the facility to the user who does not bring a child with him or her. When the level indicating the presence of the child in the selected facility is similar to the level in the average histogram, the controller 10 can determine there is no necessity to determine proving the information to the user or not based on the presence of the child.

### Other Embodiments

In the foregoing embodiments, the controller 10 executes all of the processes. As another example, in each process, the server 90 may execute a part or all of the operations. For example, the server may execute a part or all of the operations included in the statistical data preparing process. That is, the information providing device 1, 2 may be configured as a cloud system by including the server 90 as a component.

Further, the present disclosure may be provided as a program product stored in a non-transitory tangible computer readable storage medium. The program product includes instructions to be executed by a computer, the instructions for implementing acquiring one or more information elements posted by one or more posters, estimating a post situation of each of the one or more information elements, the post situation being a situation under which the corresponding information element is posted by the poster, acquiring a device situation under which the information providing device 1 is placed, determining a suitability of the device situation with a general situation of the one or more information elements posted by the posters and selecting one or more target information elements from the one or more information elements based on the suitability, and providing an information to the user based on the one or more target information elements selected based on the suitability.

In the present disclosure, the process executed by the controller 10 at S130 functions as a providing section, a process executed at S290, S320, S120 function as determination selection section. The process executed at S220 functions as a device situation acquiring section, and the process executed at S270 functions as a post situation estimation section. The process executed at S250 functions as a post information acquiring section.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. An information providing device, which provides information to a user, comprising:
a post information acquiring section acquiring one or more information elements posted by one or more posters;
a post situation estimation section estimating a post situation of each of the one or more information elements, the post situation being a situation under which the corresponding information element is posted by the poster;
a device situation acquiring section acquiring a device situation under which the information providing device is placed;
a determination selection section determining a suitability of the device situation with a general situation of the one or more information elements posted by the one or more posters and selecting one or more target information elements from the one or more information elements based on the suitability, the general situation being determined based on the post situations of the one or more information elements; and
a providing section providing the information to the user based on the selected one or more target information elements.

2. The information providing device according to claim 1, wherein
the post situation estimation section acquires a post position information included in the post situation of each of the one or more information elements, the post position information indicating a post position where the corresponding information element is posted by the poster,
the device situation acquiring section acquires a device position information included in the device situation, the device position information indicating a device position where the information providing device is positioned, and
the determination selection section:
determines, for each of the one or more information elements, a matching degree of the device situation with the post situation of the corresponding information element by comparing the device position with the post position of the corresponding information element; and
determines the suitability of the device situation with the general situation of the one or more information elements based on the matching degrees of the device situation with the respective position situations of the one or more information elements, and selects the one or more target information elements based on the suitability.

3. The information providing device according to claim 1, wherein
the determination selection section calculates a statistical data based on the respective post situations of the one or more information elements, and uses the statistical data as the general situation of the one or more information elements.

4. The information providing device according to claim 1, wherein
the post situation estimation section estimates the post situation of each of the one or more information elements based on a specific content included in the corresponding information element.

5. The information providing device according to claim 1, wherein,
for each of the one or more information elements, the post situation estimation section acquires additional information elements posted by the poster of the corresponding information element, and estimates the post situation of the corresponding information element with consideration of the additional information elements posted by the poster of the corresponding information element.

6. The information providing device according to claim 4, wherein
the post situation estimation section estimates, as a part of the post situation, a total number of one or more persons moving in company with the poster by recognizing an image included in the corresponding information element.

7. The information providing device according to claim 1, wherein,
when the providing section provides the information to the user, the providing section changes a notification mode corresponding to a suitability level of each of the one or more target information elements.
